(19) United States
(12) Patent Application Publication
(10) Pub. No.: US 2018/0173062 A1
(43) Pub. Date: Jun. 21, 2018

(54) TOUCH SUBSTRATE AND DISPLAY DEVICE

(71) Applicants: BOE TECHNOLOGY GROUP CO., LTD., Beijing (CN); Ordos Yuansheng Optoelectronics Co., Ltd., Ordos, Inner Mongolia (CN)

(72) Inventors: Yan Li, Beijing (CN); Kai Chen, Beijing (CN); Jian Sun, Beijing (CN); Cheng Li, Beijing (CN); Seong Jun An, Beijing (CN)

(21) Appl. No.: 15/512,448

(22) PCT Filed: Jun. 3, 2016
(86) PCT No.: PCT/CN2016/084703

§ 371 Date: Mar. 17, 2017

(30) Foreign Application Priority Data
Mar. 21, 2016 (CN) 201610160556.6

(51) Int. Cl. G02F 1/1343; G02F 1/1333; G06F 3/041; G06F 3/044

(52) U.S. Cl. CPC G02F 1/134309; G02F 1/13338; G06F 2203/04111; G06F 3/0412; G06F 3/044; G02F 1/13439

(57) ABSTRACT

The present disclosure provides a touch substrate and a display device. The touch substrate includes: a base substrate; a plurality of rows of touch electrodes disposed on the base substrate; and a plurality of signal lines disposed on the base substrate. The plurality of rows of touch electrodes are continuously disposed on the base substrate in a direction perpendicular to a row direction, sides of any tow adjacent rows of touch electrodes opposite to each other are matched in a concave-convex manner, and the plurality of signal lines are disposed in regions between respective touch electrodes.

### CROSS-REFERENCE TO RELATED APPLICATION

This application is a Section 371 National Stage Application of International Application No. PCT/CN2016/084703, filed on Jun. 3, 2016, entitled “TOUCH SUBSTRATE AND DISPLAY DEVICE”, which has not yet published, which claims priority to Chinese Application No. 201610160556.6, filed on Mar. 21, 2016, incorporated herein by reference in their entirety.

### BACKGROUND OF THE DISCLOSURE

### Field of the Disclosure

The present disclosure relates to a field of display technology, in particular, to a touch substrate and a display device.

### Description of the Related Art

A touch screen has become a main man-computer interaction means for personal mobile communication devices and integrated information terminals such as tablet computer, smart phone, super laptop computers and the like because of its easy operability, intuition and flexibility. The touch screen may be mainly divided into four types including resistive touch screen, capacitive touch screen, infrared touch screen and surface wave (SAW) touch screen according to touch principle. The capacitive touch screen has a multi-point touch function. Moreover, the reaction time of the capacitive touch screen is short, and the capacitive touch screen has a long life, a high transmittance, and a superior user experience. Additionally, as the process matures, a product yield of the capacitive touch screen has been significantly improved and price thereof is increasingly reduced. Thus, the capacitive touch screen has become a mainstream technology for touch interaction of small and medium size information terminals.

Typically, as shown in FIG. 1, a touch panel is provided with touch electrodes 1 and sensing electrodes 2 intersected with each other. During a touch phase, touch signals are applied to respective touch electrodes 1 in succession such that there is a difference in voltage between the touch electrode 1 to which the touch signal is being applied and another adjacent touch electrode 1 to which the touch signal is not applied. As a result, an edge electric field is generated between the two touch electrodes 1 such that liquid crystal molecules in a position where the edge electric field is generated are ineffectively deflected, resulting in a light leakage phenomenon in the touch panel.

### SUMMARY

In order to solve the above defects existed in the existing touch panel, the present disclosure provides a touch substrate and a display device, which are capable of avoiding effectively a light leakage due to an edge electric field of touch electrodes.

According to a technical scheme of the present disclosure, it is provided a touch substrate comprising a base substrate and a plurality of rows of touch electrodes disposed on the base substrate,

wherein, sides of any two adjacent touch electrodes opposite to each other are matched in a concave-convex manner, and

wherein, the touch substrate is further provided with a plurality of signal lines which are disposed in regions between respective touch electrodes.

According to some embodiments, the signal line comprises at least one of a gate line and a common electrode line.

According to some embodiments, a shape of a routing pattern of the signal line is matched with shapes of the opposite sides of two adjacent touch electrodes which delimit a region where the routing pattern of the signal line is located.

According to some embodiments, the touch substrate further comprises a plurality of columns of sensing electrodes which are arranged in a cross and insulated relation with the plurality of rows of touch electrodes.

According to some embodiments, each row of the touch electrodes comprise a plurality of touch sub-electrodes arranged in parallel, and all the touch sub-electrodes on the touch substrate are arranged in a matrix.

According to some embodiments, sides of any two adjacent touch sub-electrodes opposite to each other are matched in a concave-convex manner.

According to some embodiments, the touch substrate further comprises a plurality of data lines which are disposed in regions between any two adjacent columns of sub-electrodes, wherein, a shape of a routing pattern of the data line is matched with shapes of the opposite sides of two adjacent touch sub-electrodes which delimit a region where the routing pattern of the data line is located.

According to some embodiments, the shapes of the opposite sides of any two adjacent touch electrodes comprise any one of a zigzag shape, an S-shape and a burr shape.

According to some embodiments, the touch electrode serves to receive a common electrode signal during a display phase and to receive a touch signal during a touch phase.

According to some embodiments, the touch electrode is formed of transparent conductive material.

According to some embodiments, the transparent conductive material comprises ITO.

According to another technical scheme of the present disclosure, it is provided a display device comprising the touch substrate according to any one of the above embodiments.

### BRIEF DESCRIPTION OF THE DRAWINGS

FIG. 1 is a schematic view of an existing touch substrate;

FIG. 2 and FIG. 3 are plan views of a touch substrate according to an embodiment of the present disclosure;

FIG. 4 and FIG. 5 are schematic views showing a shape of a side of a touch electrode disposed on the touch substrate according to the embodiment of the present disclosure, respectively; and

FIG. 6 is a plan view of a touch substrate according to another embodiment of the present disclosure.

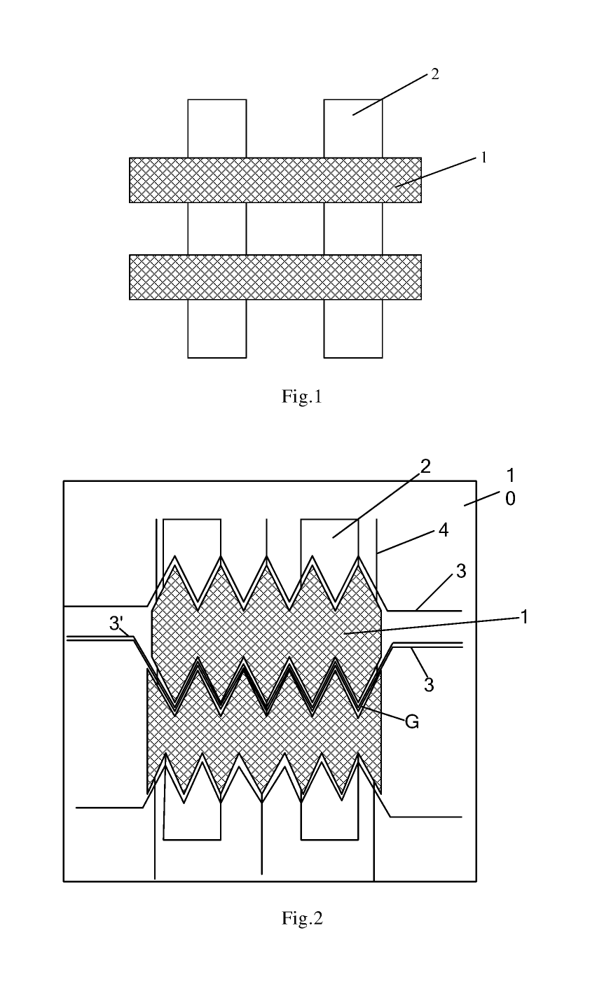

### DETAILED DESCRIPTION OF PREFERRED EMBODIMENTS OF THE DISCLOSURE

The present disclosure will be described in further detail with reference to the accompanying drawings and specific embodiments in order to provide a better understanding of the technical solutions of the present disclosure for those skilled in the art.

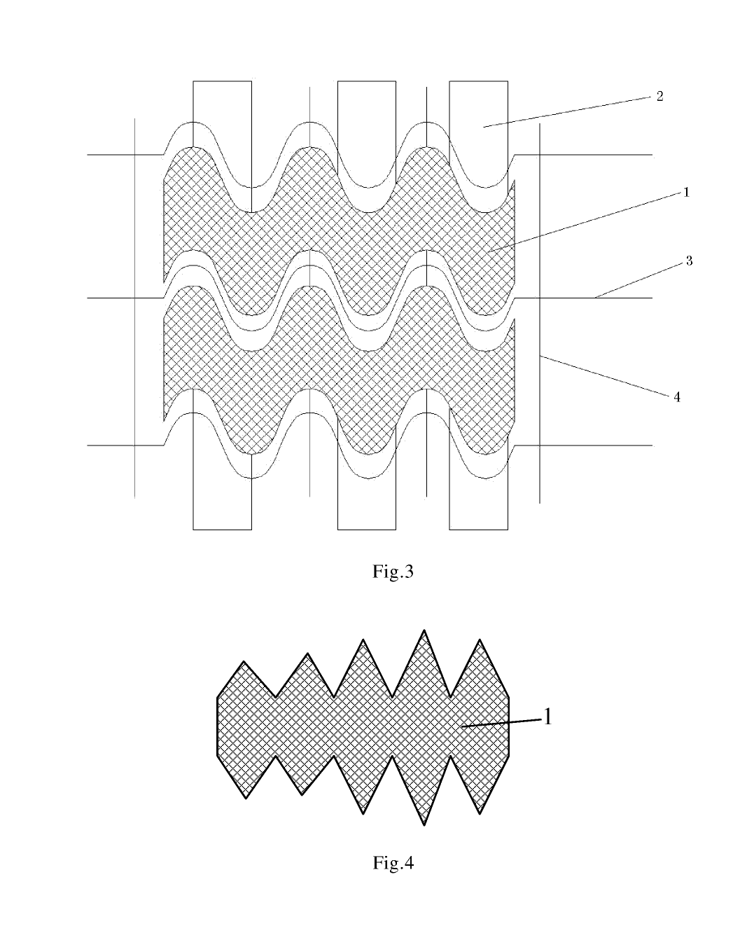

Referring to FIG. 2 and FIG. 3, an embodiment of the present disclosure provides a touch substrate which is applicable to a mutual capacitive display device. The touch substrate comprises a base substrate 10, a plurality of rows of touch electrodes 1 and a plurality of columns of sensing electrodes 2. The plurality of rows of touch electrodes 1 and the plurality of columns of sensing electrodes 2 are crossly disposed on the base substrate. Sides of any two adjacent rows of touch electrodes 1 opposite to each other are matched in a concave-convex manner. The touch substrate is further provided with a plurality of signal lines (indicated by reference numerals 3, 3′ in FIGS. 2-3) which are disposed in regions between respective touch electrodes 1. In the illustrated embodiment, the plurality of rows of touch electrodes 1 are continuously disposed on the base substrate 10 in a direction (i.e. column direction) perpendicular to a row direction such that a small gap G is presented between sides of any two adjacent rows of touch electrodes 1 which are opposite to each other. The signal line 3 is disposed in the gap G.

In the touch substrate according to the embodiment of the present disclosure, although an edge electric field is still generated between the touch electrode 1 to which a touch signal is being applied and adjacent touch electrode 1 to which the touch signal is not applied when the touch signals are applied to respective rows of touch electrodes 1 in succession, the generated edge electric field is capable of locking liquid crystal molecules in a position where the edge electric field is located so as to form a dark zone since the sides of any two adjacent touch electrodes 1 opposite to each other are matched in a concave-convex manner, thereby avoiding the light leakage phenomenon due to the deflection of the liquid crystal molecules in the position caused by the edge electric field. Moreover, the signal lines are disposed in the regions between respective touch electrodes 1, that is, in the regions (i.e. gap G) delimited by opposite sides of any two adjacent rows of touch electrodes 1, so that an aperture ratio of the touch substrate is not adversely affected.

In an embodiment, the signal line may comprise at least one of a gate line and a common electrode line. Specifically, if the touch substrate is an array substrate, the touch substrate may comprise a plurality of gate lines 3 and a plurality of data lines 4 which are disposed in a cross and insulating relation with each other. It can be understood that the gate lines 3 are typically arranged in rows and the date lines 4 are typically arranged in columns. In this case, one gate line 3 may be disposed in a region between any two adjacent rows of touch electrodes 1. Meanwhile, as shown in FIG. 2, if the array substrate is further provided with common electrodes and common electrode lines 3′ configured to supply common electrode signals to the common electrodes, it is also possible to arrange the common electrode line 3′ in the region between any two adjacent rows of touch electrodes 1, so that the aperture ratio of the touch substrate may be maximized.

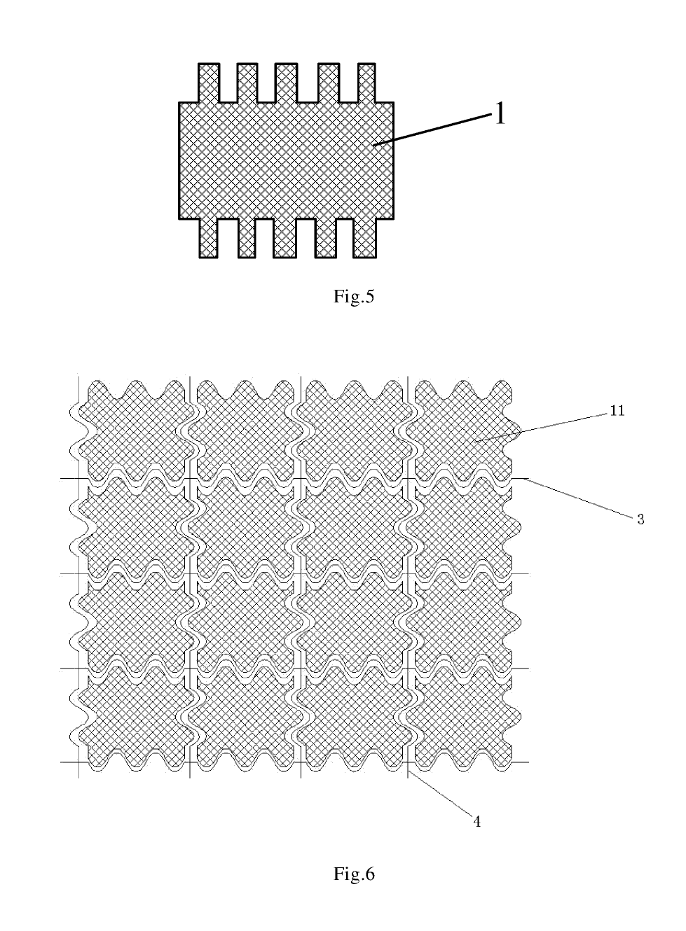

In an embodiment, a shape of a routing pattern of the signal line is matched with shapes of the opposite sides of two adjacent rows of touch electrodes 1 which delimit a region where the signal line is located. In the plan view, the shapes of the opposite sides of any two adjacent touch electrodes 1 may be any one of a zigzag shape (refer to FIG. 2), an S-shape (refer to FIG. 3) and a burr shape (refer to FIG. 4). Optionally, in the plan view, the shapes of the opposite sides of any two adjacent touch electrodes 1 may include a square-wave shape (refer to FIG. 5). In such a case, an intensity of the square-wave shape is required to be particularly large, that is, a square-wave cycle period is particularly short, so that a good effect is realized. Correspondingly, the shape of the routing pattern of the signal line may be arranged into any one of the zigzag shape, the S-shape, the burr shape and the square-wave shape. Optionally, the shape of the routing pattern of the signal line may be arranged into other curved shapes, and preferably arranged into curved shapes matched with the shape of the side of the touch electrode 1.

In an embodiment, the touch electrode 1 is formed of transparent conductive material, such as indium tin oxide (ITO). Of course, it is not limited to such material, and the touch electrode 1 may be formed of other transparent conductive materials. Further, the sensing electrode 2 may be formed of the same material as the touch electrode 1.

FIG. 6 is a plan view of a touch substrate according to another embodiment of the present disclosure. The touch substrate is applicable to self-capacitive display device. As shown in FIG. 6, the touch substrate may comprise a base substrate and a plurality of rows of touch electrodes 1 disposed on the base substrate. Each row of touch electrodes 1 may comprise a plurality of touch sub-electrodes 11 disposed in parallel. All the touch sub-electrodes on the touch substrate 1 are arranged in a matrix, that is, the touch sub-electrodes 11 are arranged on the touch substrate 1 in multi-rows and multi-columns. Each touch sub-electrode 11 serves to both transmit signals and receive signals. Further, opposite sides of any two adjacent touch sub-electrodes 11 both in a row direction and in a column direction are matched in a concave-convex manner. The touch substrate is further provided with a plurality of signal lines which are disposed in regions between respective touch sub-electrodes 11.

In the touch substrate according to the embodiment, although the edge electric field is still generated between the touch electrode 1 to which a touch signal is being applied and adjacent touch electrode 1 to which the touch signal is not applied when the touch signals are applied to respective rows of touch sub-electrodes 11 in succession, the generated edge electric field is capable of locking liquid crystal molecules in a position where the edge electric field is located so as to form a dark zone since the opposite sides of any two adjacent touch sub-electrodes 11 both in the row direction and in the column direction are matched in the concave-convex manner, thereby avoiding the light leakage phenomenon due to the deflection of the liquid crystal molecules in the position caused by the edge electric field.

In the embodiment, the signal line may comprise a data line and at least one of a gate line and a common electrode line. Specifically, if the touch substrate is an array substrate, the touch substrate may comprise a plurality of gate lines 3 and a plurality of data lines 4 which are disposed in a cross and insulating relation with each other. It can be understood that the gate lines 3 are typically arranged in rows and the date lines 4 are typically arranged in columns. In this case, one gate line 3 may be disposed in a region between any two adjacent rows of touch sub-electrodes 11, that is, in a region delimited by the opposite sides of any two adjacent rows of touch sub-electrodes 11. Meanwhile, if the array substrate is further provided with common electrodes and common electrode lines configured to supply common electrode signals to the common electrodes, it is also possible to arrange the common electrode line in the region between any two adjacent rows of touch sub-electrodes 11, so that the aperture ratio of the touch substrate may be maximized.

In an embodiment, a shape of a routing pattern of the signal line is matched with shapes of the opposite sides of a pair of adjacent touch sub-electrodes 11 which delimit a region where the signal line is located. In the plan view, the shapes of the opposite sides of any two adjacent touch sub-electrodes 11 may be any one of a zigzag shape, an S-shape and a burr shape. Optionally, in the plan view, the shapes of the opposite sides of any two adjacent touch sub-electrodes 11 may include a square-wave shape. An intensity of the square-wave shape is required to be particularly large, that is, a square-wave cycle period is particularly short, so that a good effect is realized. Correspondingly, the shape of the routing pattern of the signal line may be arranged into any one of the zigzag shape, the S-shape, the burr shape and the square-wave shape. Optionally, the shape of the routing pattern of the signal line may be arranged into other curved shapes, and preferably arranged into curved shapes matched with the shape of the side of the touch sub-electrode 11.

In the embodiment, the data line 4 may be arranged in a similar manner as the gate line 3. Specifically, the data line 4 is arranged in a region between any two adjacent columns of touch sub-electrodes 11, and a shape of a routing pattern of the data line 4 is matched with shapes of the opposite sides of a pair of adjacent touch sub-electrodes 11 which delimit a region where the data line is located, so that the aperture ratio of the touch substrate may be further increased. Of course, the data line 4 may also have other curved shapes.

In the embodiment, the touch sub-electrode 11 is formed of transparent conductive material, such as indium tin oxide (ITO). Optionally, the touch sub-electrode 11 is not limited to such material, and the touch electrode 1 may be formed of other transparent conductive materials. Further, the sensing electrode 2 may be formed of the same material as the touch electrode 1.

In an embodiment, the touch sub-electrode 11 may be used as a common electrode and a touch electrode in time division multiplexing manner. In other words, the touch sub-electrode 11 servers to receive a common electrode signal as a common electrode during a display phase and to receive a touch signal as a touch electrode during a touch phase.

In the touch substrate according to the present disclosure, although an edge electric field is still generated between the touch electrode to which a touch signal is being applied and adjacent touch electrode to which the touch signal is not applied when the touch signals are applied to respective rows of touch electrodes in succession, the generated edge electric field is capable of locking liquid crystal molecules in a position where the edge electric field is located so as to form a dark zone since the sides of any two adjacent touch electrodes opposite to each other are matched in a concave-convex manner, thereby avoiding the light leakage phenomenon due to the deflection of the liquid crystal molecules in the position caused by the edge electric field. Moreover, the signal lines are disposed between any two adjacent rows of touch electrodes so that an aperture ratio of the touch substrate is not adversely affected.

An embodiment of the present disclosure further provides a display device comprising the touch substrate according to the above embodiments. The display device may comprise any products or components having display function, such as liquid crystal panel, e-paper, mobile phone, panel computer, television, display, laptop computer, digital frame, navigator and so on. The display device according to the embodiment may have a high touch sensitivity.

It is to be understood that the above embodiments are merely exemplary implementations for explaining principles of the present disclosure, however, the present disclosure is not limited to the above embodiments. It is apparent to those skilled in the art to make various modifications and changes thereto without departing the spirit and scope of the present disclosure, and these modifications and changes should fall into the scope of the present disclosure.

1. A touch substrate comprising:
a base substrate;
a plurality of rows of touch electrodes disposed on the base substrate; and
a plurality of signal lines disposed on the base substrate;
wherein, the plurality of rows of touch electrodes are continuously disposed on the base substrate in a direction perpendicular to a row direction, and sides of any two adjacent touch electrodes opposite to each other are matched in a concave-convex manner, and
the plurality of signal lines are respectively disposed in regions between respective touch electrodes.

2. The touch substrate according to claim 1, wherein, the signal line comprises at least one of a gate line and a common electrode line.

3. The touch substrate according to claim 1, wherein, a shape of a routing pattern of the signal line is matched with shapes of the opposite sides, which delimit a region where the routing pattern of the signal line is located, of two adjacent rows of touch electrodes.

4. The touch substrate according to claim 1, further comprising a plurality of columns of sensing electrodes which are arranged in a cross and insulating relation with the plurality of rows of touch electrodes.

5. The touch substrate according to claim 1, wherein, each row of the touch electrodes comprise a plurality of touch sub-electrodes arranged in parallel, and all the touch sub-electrodes on the touch substrate are arranged in a matrix such that the touch sub-electrodes are arranged on the touch substrate in multi-rows and multi-columns.

6. The touch substrate according to claim 5, wherein, sides of any two adjacent touch sub-electrodes opposite to each other are matched in a concave-convex manner.

7. The touch substrate according to claim 6, further comprising a plurality of data lines which are respectively disposed in regions between any two adjacent columns of sub-electrodes, wherein, a shape of a routing pattern of the data line is matched with shapes of the opposite sides, which delimit a region where the routing pattern of the data line is located, of two adjacent columns of touch sub-electrodes.

8. The touch substrate according to claim 1, wherein, the shapes of the opposite sides of any two adjacent rows of touch electrodes comprise any one of a zigzag shape, an S-shape, a burr shape and a square-wave shape.

9. The touch substrate according to claim 1, wherein, the touch electrode serves to receive a common electrode signal during a display phase and to receive a touch signal during a touch phase.

10. The touch substrate according to claim 1, wherein, the touch electrode is formed of transparent conductive material.

11. The touch substrate according to claim 10, wherein, the transparent conductive material comprises indium tin oxide (ITO).

12. A display device comprising the touch substrate according to claim 1.

13. A display device comprising the touch substrate according to claim 4.

14. A display device comprising the touch substrate according to claim 5.

15. The touch substrate according to claim 6, wherein, the shapes of the opposite sides of any two adjacent rows of touch electrodes comprise any one of a zigzag shape, an S-shape, a burr shape and a square-wave shape.

16. A display device comprising the touch substrate according to claim 7.
